(19) United States
(12) Patent Application Publication
(10) Pub. No.: US 2007/0062717 A1
(43) Pub. Date: Mar. 22, 2007

(54) Device for junction box

(76) Inventors: Olav Ytreland, Haugesund (NO); Beathe Rossebo, Haugesund (NO)

Correspondence Address: SIERRA PATENT GROUP, LTD., 1657 Hwy 395, Suite 202, Minden, NV, 89423, US

(21) Appl. No.: 10/568,789

(22) PCT Filed: Aug. 19, 2004
(86) PCT No.: PCT/NO04/00250

§ 371 Date: Feb. 17, 2006

(30) Foreign Application Priority Data
Aug. 19, 2003 (NO) 20033663
Jul. 1, 2004 (NO) 20042772

(51) Int. Cl. H01H 13/04

(52) U.S. Cl. 174/57

(57) ABSTRACT

A method of installing a junction box for electrical conductors and any other cables in a concealed installation in a building component such as a wall, a ceiling or a floor. a) First, the junction box is attached to the building structure in the normal manner. The junction box has a cover with one or more magnets for indicating the center of drilling for opening up access to the junction box. b) The conduits are drawn and fixed to the junction box for conduits. c) The building component, junction box and conduits are then covered with covering building elements. d) The Junction boxes are then located by applying a powder to covering elements. The powder is magnetic and is attracted to the magnets in the cover to indicate the drilling center. e) An opening for access to the junction box is then drilled using the drilling center.

The present invention regards a method of locating an electrical junction box behind wall covering, and also a box adapted for the purpose.

When building houses and industrial buildings, the electrical installation is normally concealed. In order to conceal the wiring a network of conduits connected via junction boxes is laid, which junction boxes are located in places in the walls, ceilings and floors where switches, sockets, lamps and/or other electrical equipment will be installed prior to the mounting of plating, panelling and floors. For the sake of simplicity, the following specification will refer to covering building elements, ceilings, panelling and floors, as well as any other covering elements, as covering building elements. After this network of conduits and junction boxes has been laid, the necessary wiring can be drawn. Normally, this takes place after the covering building elements, ceiling, panelling or floor has been laid.

The junction boxes comprise a main body, often cylindrical, the top side of which is open, and the main body is provided with a number of nozzles for connecting conduits. Moreover, the box typically includes means of attaching the box to building components such as stanchions etc. Also, the junction boxes are often supplied with a provisional cover that covers all or parts of the open top side of the main body, as well as plugs arranged in the nozzles. Furthermore, the nozzles include simple connection devices for standard conduits. Standard junction boxes are used to connect wires and install equipment such as switches or sockets etc. There are also other junction boxes for special purposes, such as insert boxes for recessed lamps such as downligths.

The junction boxes have been designed to let a front part of the body extend through the covering building element, so that the front part is flush with the surface of the covering building element. This involves meticulous measuring work when mounting the covering building elements, in order to locate the junction boxes and drill the required holes in the covering elements for these junction boxes. It is desirable to have the holes in the covering building elements match the diameter of the junction box as closely as possible. It is therefore important to make an accurate hit. Inaccurate drilling will require additional work in order to repair the damage done to the wall.

A device is known from U.S. Pat. No 4,388,890, for locating hidden objects such as junction boxes. This device comprises a first annular magnet that is fixed to the junction box by means of a fastener in the form of a cover. On the side facing the wall there is a conical depression towards the central opening of the magnet, for guiding a drill that does not hit the exact centre of the magnet, in towards the central opening of the magnet. After the covering building element has been put in place, this first magnet is located by means of an annular locating magnet. After the junction box has been located by use of the locating magnet, the drill is placed in a keyhole saw in the central opening of the locating magnet and drilling is initiated. If the drill does not hit the exact centre of the first magnet, the conical depression is meant to guide the drill in towards the central opening through a combination of movement of the junction box and guiding of the drill into the correct position prior to the saw making contact with the covering building element. It seems unlikely that a junction box attached to the inside of the covering building element can be moved in this way. The chance of moving the drill by means of the conical depression will depend on the nature of the covering building element. Such movement will be possible with plaster boards but will be impeded in the case of hard boards such as chip boards or other hard boards. Another problem is that the drill on the keyhole saw is easily damaged by the magnet, in addition to which the magnet may be damaged during the centring of the drill, thus greatly reducing the service life of the magnet and the drill.

When using this device on a wall the locating magnet will be pulled by two forces, magnetism and the force of gravity. Gravity will pull the locating magnet towards the ground, causing it to end up in a position lower than the first magnet. How much lower will depend on the wall thickness, the wall structure and the dexterity of the person carrying out the operation.

A device such as that described in this publication will normally be a separate tool to be purchased specially by the craftsman and placed in those boxes that need to be located.

Then it will be taken along to the next job. Consequently usage will be dependent on availability and acquisition cost.

This publication also describes the locating magnet as taking a different form, consisting of several parts and being made from a material that is attracted by magnets without itself being magnetic. However no examples of any other embodiments than that of the annular locating magnet are given.

U.S. Pat. No. 6,452,097 also regards equipment for locating a junction box behind a covering building element in order then to make a hole in the wall for accessing same. Here use is also made of a magnet placed centrally in the junction box opening. However, a separate electronic sensor is used for localization, making the equipment both complex and costly.

Thus it is an object of the present invention to provide an improved method of installing junction boxes in concealed installations.

According to the present invention this object is achieved by a method of installing a junction box for electrical conductors and any other cables in a concealed installation, in a building component such as a wall, a ceiling or a floor, the method comprising the steps of:
a) attaching the junction box to the building structure in the normal manner,
b) drawing conduits and fixing these to the junction box for conduits,
c) covering the building component, junction box and conduits with covering building elements,
d) locating the junction boxes,
e) drilling an opening for access to the junction box,
   where use is made of a junction box with a cover that includes one or more magnets for indicating the centre of drilling for opening up access to the junction box, and that the localization in step d) includes the application of a powder which is attracted to magnetism, on the surface of the covering building element, causing the powder to form spots over each magnet, wherein the centre of the spots indicates the drilling centre for step e).

It is furthermore an object of the present invention to provide a simple, inexpensive and reliable method of locating a junction box behind a covering building element, which method avoids the above drawbacks and the requirement for special equipment is avoided or at least greatly reduced.

According to a second aspect of the present invention this object is achieved by a method of locating the centre for drilling in a covering building element to gain access to a junction box behind the covering building element, wherein the junction box is fitted with a cover that includes one or more magnets, and where a powder is applied which is attracted to the surface of the covering building element by magnetism, and that the centre of the spots of powder that collect over the magnet(s) is marked as the drilling centre.

It is also an object to provide a device for use with the method. According to a third aspect of the present invention there is provided a cover for a junction box comprising a substantially plane surface of an area that on the whole corresponds to the opening in the junction box body, and a part projecting from the plane and which is adapted for external or internal engagement with the junction box, in which cover there is disposed one or more magnets, wherein the magnet or magnets are placed so as to indicate the centre for drilled holes that are required to gain access to the junction box, with weak zones arranged in the cover around each magnet, allowing the magnet and the part of the cover to which it is attached, to be pressed into the cavity of the junction box.

The term drilling, as used in the present invention, covers drilling and sawing by use of a keyhole saw or similar.

The following describes the present invention in greater detail with reference to the accompanying drawings, in which:

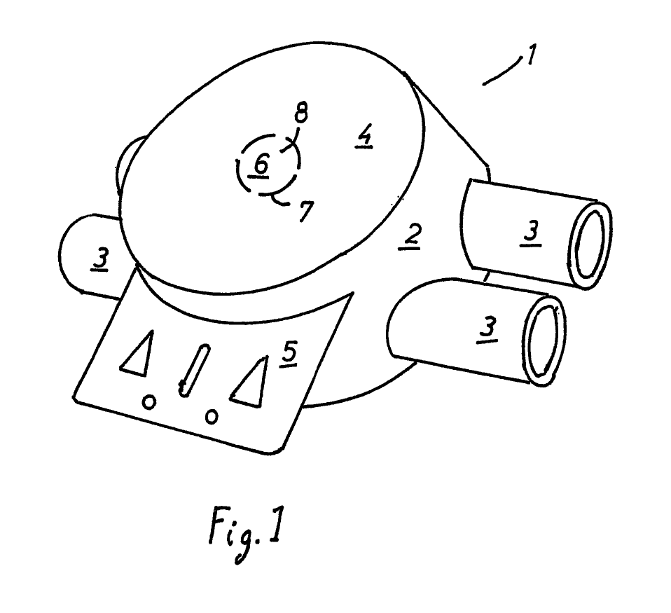

FIG. 1 is a perspective view of a junction box;

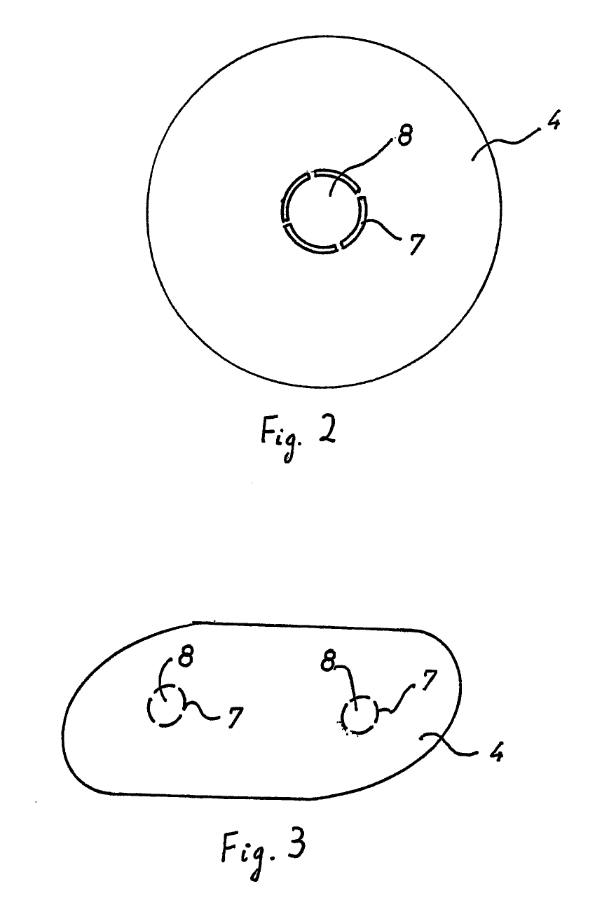

FIG. 2 is a cross section through a cover for a junction box;

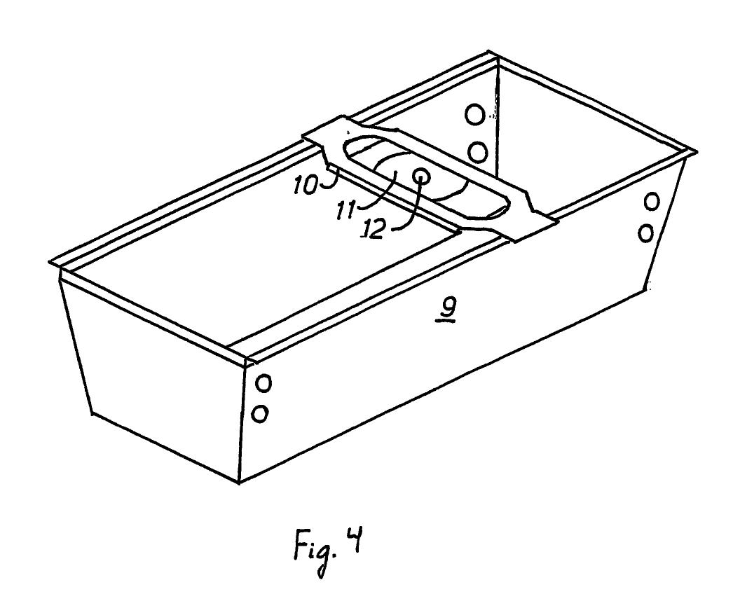

FIG. 3 shows a cover for a junction box with a non-circular cross section; and

FIG. 4 is a perspective view of a box for installation of a lamp.

FIG. 1 shows a junction box 1 with a generally cylindrical body 2 of a generally circular cross section. On the body 2 there are a number of nozzles 3 for connection to conduits (not shown). The cylindrical body has sealed end face and an open end face that upon delivery is covered by a cover 4.

A magnet 6 is attached to the centre of the cover 4. Preferably the magnet 6 is moulded to the cover during manufacture. However, the magnet may also be fixed to the cover by other means.

Around the magnet 6 there is a weak zone 7 in the cover, located around a target section 8. The notches ensure that the target section 8 with the magnet is pushed into the internal cavity of the body 2 upon contact with a drill, to prevent the magnet from impeding the drilling and damaging the drill.

The junction box shown also has a plate fastener 5 for attaching the junction box to a stanchion in the wall. During installation, the junction box is fixed to a stanchion by fixing the plate fastener 5 by means of mounting devices such as nails, screws or similar. The plate fastener 5 may also be formed as a punched metal plate fastener with one or more “nails”, which can be used as a stand-alone device or with other mounting devices. The junction box may also include other mounting devices for fixing to other structures such as sleepers, roof constructions or similar.

After the junction boxes have been fixed and the conduits laid the building component, e.g. a wall, a floor or a ceiling, can be covered with covering building elements so as to encase and cover the junction boxes with the elements. Then a magnetically attracted powder, e.g. iron filings, is applied to an area in which a junction box is known to be located. The manner in which the powder is applied, and whether any additional steps are required in order to reliably located the magnet and thereby the junction box, will depend on the type of building component in question, i.e. whether it is a ceiling, a floor or a wall. On a wall, the powder is applied by sprinkling it down the wall. The powder will then collect over the magnet. If necessary, more powder may be applied locally in the area where the first sprinkling indicates the existence of a box. On a floor it may be necessary to blow or otherwise move the powder in order to bring about a collection of the powder over the junction boxes. Application of powder to a ceiling can be done by sprinkling it on a board which is then brought up to the ceiling. The magnets will then attract the powder, thereby indicating the location of the junction boxes.

After a junction box has been reliably located by means of the powder, the centre of the collected powder is marked, the brad point of a keyhole saw or similar is placed against this mark and drilling is initiated. If the marking is correct, the drill will hit the target section 8 after going through the covering building element, at least partly breaking it off from the cover and forcing the target section into the internal cavity of the body. The keyhole saw will then make a hole matching the body, providing full access to the interior of this from the outside of the covering building element.

The embodiment in FIG. 3 shows a cover having two magnets. The method of locating this junction box is the same as that described above. Following localization two holes are drilled, one for each magnet, in the same manner as above. Then it is necessary to saw between the two drilled holes in order to bring out the entire cross section of the body. The present invention is also highly suited for use with this type of junction box, and simplifies the localization and drilling operations considerably.

The execution of the magnet 6 is not important to the present invention. However, the polarity of the magnet should be such that the axis between the poles of the magnet is approximately normal on the plane of the cover, and also the part of the magnet abutting the cover should be level. For reasons of manufacturing techniques, it is preferable for the magnet to have the shape of a short cylinder with a circular cross section.

The embodiment shown is the most preferred, having one or more magnets placed in the cover, one magnet for indicating the centre of each hole to be drilled. The number of magnets in the cover will then be determined by the cross section of the junction box and how many holes are deemed to be necessary in order to achieve an opening that is sufficient to provide access to the box.

Moreover the cover does not need to cover the entire opening in the body of the junction box. The important thing is for the cover to provide support for the magnet, so that this is held against or near the covering building element and the magnet is kept at the centre of the intended drilling. Above the invention is described with reference to junction boxes in which are drilled holes that correspond to the opening in the body facing the covering building element. Often this will not be the case if the junction box is a mounting box 9 for a recessed lamp such as a downlight like the one shown in FIG. 4. Generally the bore will then be smaller than the opening in the box facing the covering building element, to allow an air space to form around a recessed lamp inside the box. Furthermore it is often preferable for such boxes to provide the possibility of aligning a number of bores for different boxes in a straight line. The boxes may then be installed so as to form a substantially straight line. The cover may then be designed in a manner such that the magnet or a part of the cover where the magnet is located can be displaced relative to the box, as shown in FIG. 4. A final correction of the drilling centre can then be made by displacing the magnets of junction boxes placed in a line, so as to line the drilling centres of the boxes up exactly. In order to achieve this, a cover 10 that is displaceable along one axis of the box is adjusted, in addition to which a magnet holder 11 with a magnet 12 on the cover 10 can be displaced at right angles to the direction of the cover.

1. A method of installing a junction box for electrical conductors and any other cables in a concealed installation in a building component the method comprising the steps of:
a) attaching the junction box to the building structure,
b) drawing conduits and fixing said conduits to the junction box for conduits,
c) covering the building component, junction box and conduits with covering building elements,
d) locating the junction boxes, and
e) drilling an opening for access to the junction box,
characterized in that the junction box used has a cover with one or more magnets for indicating the centre of drilling for opening up access to the junction box and that the localization locating in step d) includes the application of a powder which is attracted by magnetism, on the surface of the covering building element, causing the powder to form into spots over each magnet, and where the centre of the spots indicates the drilling center for step e).

2. A method according to claim 1,
characterized in that the powder attracted by magnetism consists of iron filings.

3. A method of locating the center of drilling in a covering building element in order to gain access to a junction box behind the covering building element, wherein the junction box is fitted with a cover having one or more magnets,
characterized in that a magnetically attracted powder is applied to the surface of the covering building element, and that the center of the spots of powder that collect over the one or more magnets, is marked as the drilling center.

4. A cover for a junction box, comprising a substantially plane surface having an area that in the main corresponds to the opening in the body of the junction box, and a part projecting from the plane and which is adapted for external or internal engagement with the junction box, in which the cover is provided one or more magnets, wherein the one or more magnets are placed so as to indicate the center for drilled holes that are required to gain access to the junction box, characterized in that the cover includes weak zones arranged around each magnet allowing each magnet and the part of the cover to which it is attached, to be pressed into the cavity of the junction box.
